(19) United States
(12) Patent Application Publication
(10) Pub. No.: US 2001/0024162 A1
(43) Pub. Date: Sep. 27, 2001

(54) Optical intrusion detection system using mode coupling

(76) Inventor: Wan-Ku Lee, Kyungki-do (KR)

Correspondence Address: Charles F. Wieland III, BURNS, DOANE, SWECKER & MATHIS, L.L.P., P.O. Box 1404, Alexandria, VA, 22313-1404, US

(21) Appl. No.: 09/794,097

(22) Filed: Feb. 28, 2001

(30) Foreign Application Priority Data
Feb. 29, 2000 (KR) 00-10061

(51) Int. Cl. G08B 13/18

(52) U.S. Cl. 340/555; 340/556; 340/557

(57) ABSTRACT

An optical intrusion detection system including a light source, an optical splitter for splitting light emitted from the light source and transmitted via an optical fiber, a plurality of detectors for detecting light power values split by the optical splitter, and a determiner for determining intrusion or non-intrusion by performing a predetermined operation on the output of each of the detectors. According to this system, light having mode coupling while traveling through a multi-mode optical fiber is split, and the split light power values are measured and compared to each other, so that a dynamic change of an optical signal and a static change in light loss due to the physical disturbance from an intruder can be simultaneously measured. Also, an optical splitter can be designed in consideration of the external environment.

### BACKGROUND OF THE INVENTION

1. Field of the Invention

The present invention relates to an optical intrusion detection system using mode coupling, and more particularly, to an optical intrusion detection system using mode coupling in a multi-mode optical fiber.

2. Description of the Related Art

Optical intrusion detection systems, which are to detect intrusion using optical fiber, are installed in the security area or restricted area of military units, airports, power plants and the like to protect their facilities from intruders. These systems can reduce the number of security guards and provide means for stable communications through a built-in optical fiber.

The following three representative techniques are currently used in products: a method of measuring a change in a dynamic component of an optical signal using optical speckles; a method of measuring a static change in optical loss; and a method of measuring a change using optical time domain reflectometry (OTDR). However, all of the three techniques have a high false alarm rate.

First of all, a system for detecting intrusion using optical speckles determines intrusion or non-intrusion by blocking a part of light transmitted in a continuous wave form via a multi-mode optical fiber and measuring optical speckles or light power resulting from the interference of the remaining unblocked light. However, this system is sensitive to surrounding changes since it senses only a dynamic change component generated by intruders.

An alternative optical intrusion detection technique is a method of detecting light loss caused when an optical fiber is bent or cut. However, this method is dull to dynamic changes such as shock waves and other physical disturbances of an optical fiber.

Another alternative optical intrusion detection technique is a method using back scattering of an optical pulse. In this method, intrusion or non-intrusion is determined by detecting light which is scattered back by a light transmission medium while light is transmitted in a pulse form. This method has a feature in that even the position on an optical fiber where disturbance occurs can be detected. However, this method involves complicated signal processing, and has a higher false alarm rate than other techniques.

Therefore, a simple optical intrusion detection system capable of easily measuring the dynamic and static changes of light power is required.

### SUMMARY OF THE INVENTION

To solve the above problems, an objective of the present invention is to provide an optical intrusion detection system for determining intrusion or non-intrusion by splitting light emitted from a light source and detecting and comparing the power of the split light.

To achieve the above objective, the present invention provides an optical intrusion detection system including: a light source; an optical splitter for splitting light emitted from the light source and transmitted via an optical fiber; a plurality of detectors for detecting light power values split by the optical splitter; and a determiner for determining intrusion or non-intrusion by performing a predetermined operation on the output of each of the detectors.

### BRIEF DESCRIPTION OF THE DRAWINGS

The above objective and advantages of the present invention will become more apparent by describing in detail a preferred embodiment thereof with reference to the attached drawings in which:

FIG. 1 is a block diagram of an optical intrusion detection system according to the present invention;

FIGS. 2A and 2B are graphs showing power spectrums with respect to frequency in a normal state and an intrusion state, respectively;

FIGS. 3A and 3B are graphs showing an alternating current (AC) component varying due to the difference between the output signals of the first and second detectors of FIG. 1, with respect to time, in a normal state and in an intrusion state, respectively; and

FIGS. 4A and 4B are graphs showing a direct current (DC) component varying depending on the sum of the output signals of the first and second detectors of FIG. 1, with respect to time, in a normal state and in an intrusion state, respectively.

### DESCRIPTION OF THE PREFERRED EMBODIMENT

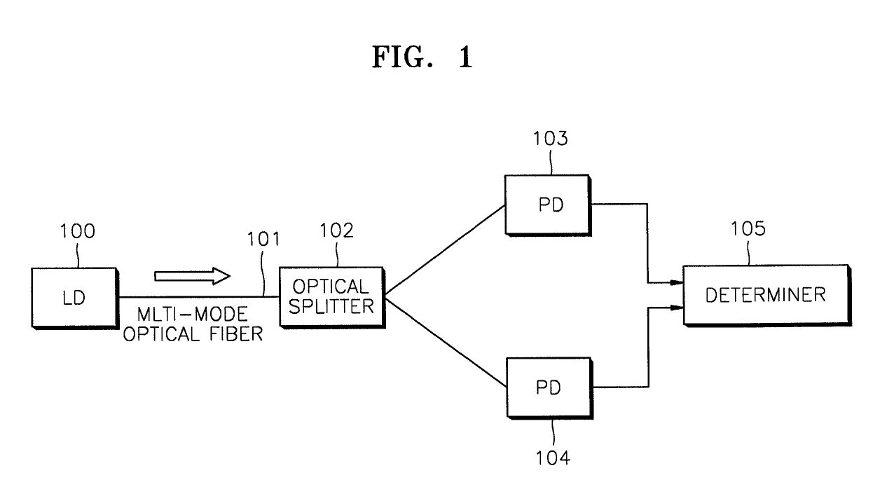

FIG. 1 is a block diagram of an optical intrusion detection system according to the present invention. When an optical signal output from a laser diode which outputs a continuous wave is coupled to a multi-mode optical fiber, it travels in a multi-mode form because of the characteristics of the optical fiber. When an intruder physically disturbs the multi-mode optical fiber through which the optical signal is traveling, light power transition occurs between the modes of light traveling within the optical fiber. If the modes of light travel into an optical splitter realized of multi-mode optical fibers, the power of each of the split beams of light output from the optical splitter differs from each of the others because each coupling coefficient of the modes differs in the optical splitter. Thus, the optical intrusion detection system can detect the physical disturbance by measuring changes in power of the split light at the output port.

Referring to FIG. 1, the optical intrusion detection system includes a light source 100, a multi-mode optical fiber 101 for transmitting light emitted from the light source 100, an optical splitter 102 for splitting light transmitted by the multi-mode optical fiber 101, first and second detectors 103 and 104 for detecting the powers of lights split by the optical splitter 102, and a determiner 105 for determining intrusion or non-intrusion using the detected powers of lights. Preferably, the light source 100 is a laser diode for continuously outputting laser light.

In the operation of the optical intrusion detection system, when laser light continuously output from the light source 100 is coupled to the multi-mode optical fiber 101, it proceeds in a multi-mode due to the characteristics of the multi-mode optical fiber 101. At this time, when an intruder physically disturbs the multi-mode optical fiber 101 through which light travels, each mode of the light is transited to another mode (that is, mode coupling occurs), light power split of each mode changes. Here, mode coupling denotes power coupling between modes. The light power split of each mode is different for each mode since the modes within the optical splitter 102 have different coupling coefficients. Thus, the power of light split and output by the optical splitter 102 is changed. The first and second detectors 103 and 104 measure the power of light beams output from the optical splitter 102. The determiner 105 can determine the static and dynamic changes of light power by comparing the light power values detected and output from the first and second detectors 103 and 104 with each other through the subtraction and addition of the light power values. Also, the optical splitter 102 is designed in consideration of the surrounding environment in order to selectively control the sensitivity to the surrounding environment.

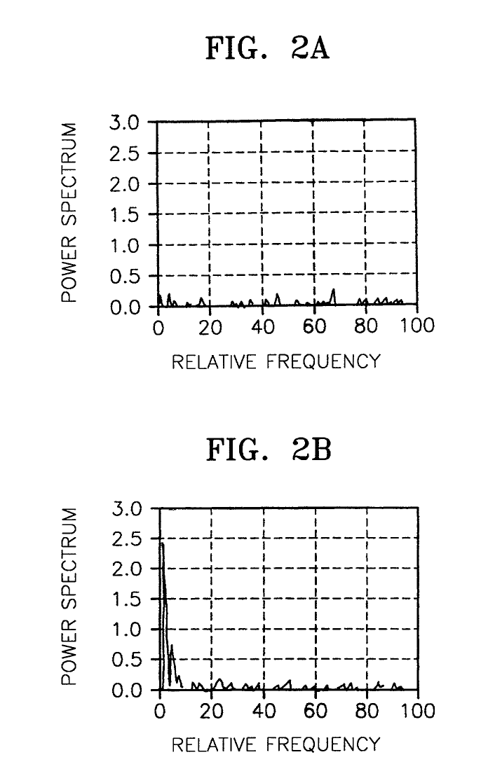

FIGS. 2A and 2B are graphs showing power spectrums with respect to frequency in a normal state and an intrusion state, respectively. As shown in FIG. 2B, a power spectrum around a low frequency changes in the case that intrusion occurs.

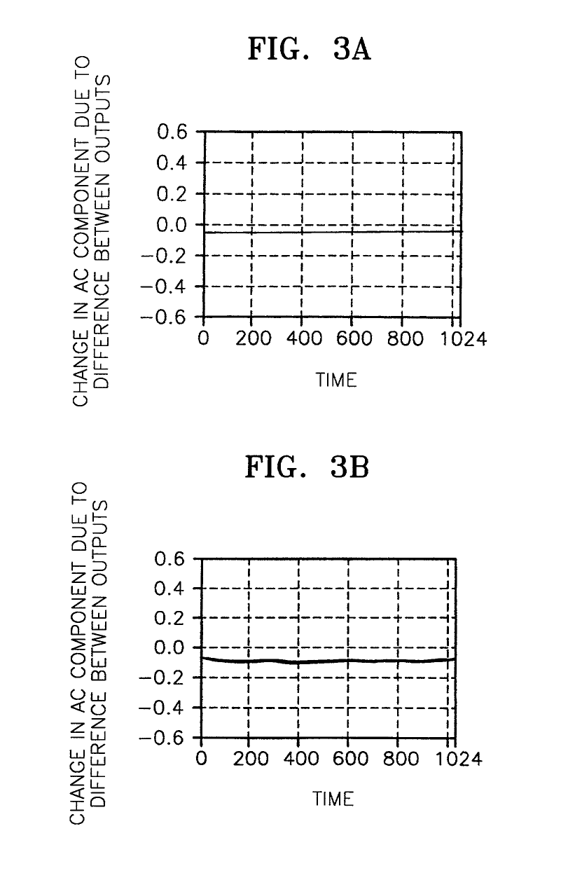

FIGS. 3A and 3B are graphs showing an alternating current (AC) component varying due to the difference between the output signals of the first and second detectors of FIG. 1, with respect to time, in a normal state and in an intrusion state, respectively. As shown in FIG. 3B, a change occurs in an intrusion state rather than a normal state.

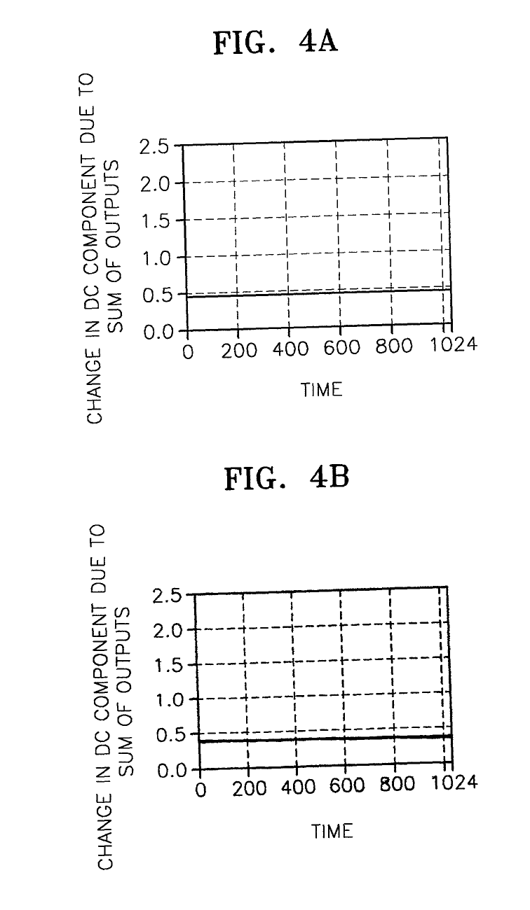

FIGS. 4A and 4B are graphs showing a direct current (DC) component varying due to the sum of the output signals of the first and second detectors of FIG. 1, with respect to time, in a normal state and in an intrusion state, respectively. As shown in FIG. 4B, the DC component is smaller in an intrusion state than in a normal state.

According to the present invention, light having mode coupling while traveling through a multi-mode optical fiber is split, and the split light power values are measured and compared to each other, so that a dynamic change of an optical signal and a static change in light loss due to the physical disturbance from an intruder can be simultaneously measured. Also, an optical splitter can be designed in consideration of the external environment.

What is claimed is:

1. An optical intrusion detection system comprising:
a light source;
an optical splitter for splitting light emitted from the light source and transmitted via an optical fiber;
a plurality of detectors for detecting light power values split by the optical splitter; and
a determiner for determining intrusion or non-intrusion by performing a predetermined operation on the output of each of the detectors.

2. The optical intrusion detection system of claim 1, wherein the light source is a laser diode that continuously outputs laser light.

3. The optical intrusion detection system of claim 1, wherein the optical splitter changes the power split between modes due to mode coupling which occurs within the multi-mode optical fiber, when the multi-mode optical fiber is disturbed.

4. The optical intrusion detection system of claim 1, wherein the determiner determines intrusion or non-intrusion by extracting an alternating current (AC) component varying due to the difference between the output signals of the plurality of detectors.

5. The optical intrusion detection system of claim 1, wherein the determiner determines intrusion or non-intrusion by extracting the AC component varying due to the difference between the output signals of the plurality of detectors and a direct current (DC) component varying due to the sum of the output signals thereof.
